(19) United States
(12) Patent Application Publication
(10) Pub. No.: US 2025/0246352 A1
(43) Pub. Date: Jul. 31, 2025

(54) ELECTROMAGNETIC REPLICATION

(71) Applicant: GLOBAL ENERGY APPLICATIONS, LLC, BARTOW, FL (US)

(72) Inventor: Brian K. Cook, LAKELAND, FL (US)

(21) Appl. No.: 19/035,296

(22) Filed: Jan. 23, 2025

Related U.S. Application Data
(60) Provisional application No. 63/625,322, filed on Jan. 26, 2024.

(51) Int. Cl. H01F 7/06; H01F 27/24; H01F 27/28

(52) U.S. Cl. CPC H01F 7/064; H01F 27/24; H01F 27/28

(57) ABSTRACT

Electromagnetic replication wherein there is no detectable voltage when an inductor coil is subjected to a magnetic field, the amount of current is proportional to the mass of the material in circumference and the strength of the magnetic field, as long as no resistance interferes there will be no voltage. Voltage only starts to show when resistance is present. When a primary coil in a first magnetic core has a current, it also produces a magnetic field. That magnetic field will cause another current and magnetic field in a corresponding second magnetic core. When the inductor coil forming the magnetic core forms a closed loop, the magnetic field and current produces will be a replication of the primary coil. By attaching another coil to the secondary and not having resistance, the attached coil will also have the same current and magnetic field and the same process starts over.

### PRIORITY CLAIM

In accordance with 37 C.F.R. §1.76, a claim of priority is included in an Application Data Sheet filed concurrently herewith. Accordingly, the present invention claims priority to U.S. Provisional Patent Application No. 63/625, 322, entitled “ELECTROMAGNETIC REPLICATION”, filed Jan. 26, 2024. The contents of the above referenced application are incorporated herein by reference.

### FIELD OF THE INVENTION

This invention is directed to an addition to conventional AC circuitry and, in particular, to a circuit for electromagnetic replication for generating a secondary field.

### REVELANT PRIOR ART

This invention is related to U.S. Pat. No. 11,309,735 entitled Non-Vibrational Electromagnetic Energy Harvester issued Apr. 19, 2022 the contents of which is incorporated herein by reference.

### SUMMARY OF THE INVENTION

It is commonly accepted that a primary winding and secondary winding operate on a magnetic core by creating a magnetic field that induces a voltage in the secondary winding. When an alternating current (AC) flows through the primary winding, it creates a magnetic field around the magnetic core. This magnetic field then interacts with the turns of wire in the secondary winding, inducing a voltage across the secondary winding. The voltage induced in the secondary winding is proportional to the number of turns in the secondary winding and the rate of change of the magnetic field. The magnetic core is used to enhance the magnetic coupling between the primary and secondary windings. It serves as a pathway for the magnetic flux, ensuring that a maximum amount of magnetic flux is transferred from the primary to the secondary winding. This allows for a more efficient transfer of energy between the primary and secondary windings. The magnetic core enhances the magnetic coupling between the two windings, allowing for a more efficient transfer of energy.

Conventional electrical devices that draw an electrical load, such as AC motors and the like, require a source of power for operation; the actual load requiring a certain voltage and current draw, or electromotive force, for movement of current through a circuit. The operation of an electric motor depends upon the interaction between the motor's magnetic field and electric current in a wire winding to generate torque upon a drive shaft. For instance, older AC motors operate most efficiently with a high power factor. Increasing the power factor increases the current.

In an induction motor, the primary winding with voltage and current that generates a magnetic field. The magnetic field interacts with another inductor (solid or wound) that also generates a magnetic field. The two fields are counter rotating. If the leads on the secondary coil of core one were open, then the coil would have voltage but no current. That coil would also have NO magnetic field. By shorting the leads together, it has a complete connection meaning all of the mass of the inductor is in physical contact with itself, just like it was solid.

By connecting another coil to that coil and having no resistance in the connections, it causes the add-on coil to also have current without voltage, meaning the same magnetic field. This allows another magnetic field that can interact with another coil generating new magnetic field. If the secondary can be attached to what would be another primary the process can be repeated with no effect on the original primary.

An objective of the invention is to generate a usable magnetic field without using additional current providing electromagnetic replication.

Another objective of the invention is to teach the use of a magnetic field to control voltage and current.

Another objective of the invention is to suggest modification of an induction motor to provide more power without more current.

Still another objective of the invention is to teach electromagnetic replication wherein current is detected, and there is no detectable voltage.

Other objectives, advantages and benefits associated with this invention will be apparent to those skilled in the art from the description, examples and the claims which follow.

### BRIEF DESCRIPTION OF THE DRAWINGS

FIG. 1 is a pictorial schematic of the electromagnetic replication instant invention.

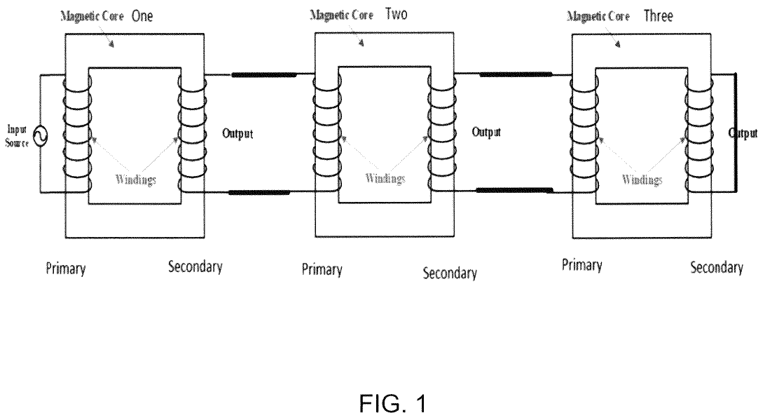

### DETAILED DESCRIPTION OF THE PREFERRED EMBODIMENT

A detailed embodiment of the instant invention is disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

Electromagnetic replication wherein there is no detectable voltage when an inductor coil is subjected to a magnetic field, the amount of current is proportional to the mass of the material in circumference and the strength of the magnetic field, as long as no resistance interferes there will be no voltage. Voltage only starts to show when resistance is present. When a primary coil in a first magnetic core has a current, it also produces a magnetic field. That magnetic field will cause another current and magnetic field in a corresponding second magnetic core. When the inductor coil forming the magnetic core forms a closed loop, meaning the leads are shorted together, the magnetic field and current produces will be a replication of the primary coil if all things are equal. By attaching another coil to the secondary and not having resistance, the attached coil will also have the same current and magnetic field and the same process starts over.

In an exemplary embodiment, three magnetic cores are placed in series. In every stage the main focus is the magnetic field. Voltage is only applied to a primary winding input of the first magnetic core. A secondary winding of the first magnetic core produces a first output. The first output of the first magnetic core is electrically coupled to a primary winding of the second magnetic core. The seconding winding of the second magnetic core produces a second output. The second output of the second magnetic core is electrically coupled to a primary winding of the third magnetic core. The secondary winding of the third magnetic core produces a third output.

When the primary coil in the first magnetic core has a current, it also produces a magnetic field. That magnetic field will cause another current and magnetic field in a corresponding second magnetic core. When the inductor coil forming the magnetic core forms a closed loop, meaning the leads are shorted together, the magnetic field and current produces will be a replication of the primary coil if all things are equal. By attaching another coil to the secondary and not having resistance, the attached coil will also have the same current and magnetic field and the same process starts over.

Each magnetic core is attached to the next core by a pair of leads, but each coil is separate within the core housing. In one embodiment, a magnetic field replication system, comprises a first magnetic core comprising: a primary winding configured to receive an input voltage and generate a first magnetic field, and a secondary winding configured to produce a first output; a second magnetic core comprising: a primary winding electrically coupled to the secondary winding of the first magnetic core and configured to receive the first output to generate a second magnetic field, and a secondary winding configured to produce a second output; wherein the secondary winding of each magnetic core is electrically shorted to ensure the magnetic field and current produced replicate the magnetic field and current of the first magnetic core.

The system may further comprise an additional a third magnetic core comprising: a primary winding electrically coupled to the secondary winding of the second magnetic core and configured to receive the second output to generate a third magnetic field, and a secondary winding configured to produce a third output.

The secondary winding of the second magnetic core is shorted to ensure that the magnetic field and current in each magnetic core replicate the magnetic field and current generated by the first magnetic core.

Additional magnetic cores can be electrically connected in series, each additional magnetic core comprising: a primary winding electrically coupled to the secondary winding of the preceding magnetic core, and a secondary winding electrically shorted to replicate the magnetic field and current generated by the first magnetic core. The leads of the secondary winding in each magnetic core are shorted to eliminate resistance and voltage while maintaining current flow and magnetic field replication. The current and magnetic field produced by each magnetic core are independent of the current draw from the primary winding of the first magnetic core. For example, if 4 cores connected together, as long as the last secondary coil has the leads shorted together, then all coils will have the same current and magnetic field as the primary coil from the first magnetic core with no effect on primary draw. When an inductor coil is subjected to a magnetic field and its leads are shorted together the coil will try to create a magnetic field of the same magnitude as the primary field. When the coil has no resistance, meaning shorted leads there will be no voltage.

The invention can be applied as a method for replicating a magnetic field across a series of magnetic cores, comprising: applying a voltage to a primary winding of a first magnetic core to generate a first magnetic field; producing a first output from a secondary winding of the first magnetic core; transmitting the first output to a primary winding of a second magnetic core to generate a second magnetic field; producing a second output from a secondary winding of the second magnetic core; transmitting the second output to a primary winding of a third magnetic core to generate a third magnetic field; producing a third output from a secondary winding of the third magnetic core; shorting the leads of the secondary winding in each magnetic core to ensure the magnetic field and current in each core replicate the magnetic field and current of the first magnetic core.

The method allows additional magnetic cores are connected in series, with each magnetic core receiving an output from the preceding core and replicating the magnetic field and current generated by the first magnetic core. Shorting the leads of the secondary winding eliminates resistance and voltage while maintaining current flow and magnetic field replication.

The magnetic field and current produced by each magnetic core are independent of the input current to the primary winding of the first magnetic core. The system achieves magnetic field replication across a plurality of magnetic cores with no additional effect on the input voltage applied to the first magnetic core.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A magnetic field replication system, comprising:
a first magnetic core comprising: a primary winding configured to receive an input voltage and generate a first magnetic field, and a secondary winding configured to produce a first output;
a second magnetic core comprising: a primary winding electrically coupled to the secondary winding of the first magnetic core and configured to receive the first output to generate a second magnetic field, and a secondary winding configured to produce a second output;
wherein the secondary winding of each magnetic core is electrically shorted to ensure the magnetic field and current produced replicate the magnetic field and current of the first magnetic core.

2. The system of claim 1, further comprising an additional a third magnetic core comprising: a primary winding electrically coupled to the secondary winding of the second magnetic core and configured to receive the second output to generate a third magnetic field, and a secondary winding configured to produce a third output.

3. The system of claim 1, wherein the secondary winding of the second magnetic core is shorted to ensure that the magnetic field and current in each magnetic core replicate the magnetic field and current generated by the first magnetic core.

4. The system of claim 2, further comprising additional magnetic cores electrically connected in series, each additional magnetic core comprising: a primary winding electrically coupled to the secondary winding of the preceding magnetic core, and a secondary winding electrically shorted to replicate the magnetic field and current generated by the first magnetic core.

5. The system of claim 1, wherein the leads of the secondary winding in each magnetic core are shorted to eliminate resistance and voltage while maintaining current flow and magnetic field replication.

6. The system of claim 1, wherein the system operates such that the current and magnetic field produced by each magnetic core are independent of the current draw from the primary winding of the first magnetic core.

7. A method for replicating a magnetic field across a series of magnetic cores, comprising:
applying a voltage to a primary winding of a first magnetic core to generate a first magnetic field;
producing a first output from a secondary winding of the first magnetic core;
transmitting the first output to a primary winding of a second magnetic core to generate a second magnetic field;
producing a second output from a secondary winding of the second magnetic core;
transmitting the second output to a primary winding of a third magnetic core to generate a third magnetic field;
producing a third output from a secondary winding of the third magnetic core;
shorting the leads of the secondary winding in each magnetic core to ensure the magnetic field and current in each core replicate the magnetic field and current of the first magnetic core.

8. The method of claim 7, wherein additional magnetic cores are connected in series, with each magnetic core receiving an output from the preceding core and replicating the magnetic field and current generated by the first magnetic core.

9. The method of claim 7, wherein shorting the leads of the secondary winding eliminates resistance and voltage while maintaining current flow and magnetic field replication.

10. The method of claim 7, wherein the magnetic field and current produced by each magnetic core are independent of the input current to the primary winding of the first magnetic core.

11. The method of claim 7, wherein the system achieves magnetic field replication across a plurality of magnetic cores with no additional effect on the input voltage applied to the first magnetic core.
